(19) United States
(12) Patent Application Publication
(10) Pub. No.: US 2012/0224728 A1
(43) Pub. Date: Sep. 6, 2012

(54) SPEAKER ASSEMBLY INCORPORATING WOOFER AND TWEETER

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/470,375

(22) Filed: May 14, 2012

Related U.S. Application Data
(63) Continuation-in-part of application No. 13/104,027, filed on May 10, 2011.

(30) Foreign Application Priority Data
Dec. 24, 2010 (CN) 201010604421.7

(51) Int. Cl. H04R 1/00

(52) U.S. Cl. 381/184

(57) ABSTRACT

An exemplary speaker assembly includes a woofer, a tweeter, and a bracket supporting the tweeter within the woofer. The woofer includes a magnetic circuit unit defining a magnetic gap, a frame attached on the magnetic circuit unit, a diaphragm attached to the frame, and a voice coil attached to the diaphragm and extending into the magnetic gap. The bracket includes an outer ring fixed relative to the frame, an inner ring surrounded by the outer ring, and ribs interconnecting the outer ring and the inner ring. The tweeter includes a main body, a supporting body, and a confining body. The supporting body is partly received in and abuts against the inner ring.

### CROSS-REFERENCE TO RELATED APPLICATIONS

The present application is a continuation-in-part (CIP) application of patent application Ser. No. 13/104,027 entitled “SPEAKER ASSEMBLY” and filed on May 10, 2011, whose disclosure is incorporated herein by reference in its entirety.

### BACKGROUND

1. Technical Field

The disclosure generally relates to speaker assemblies, and more particularly, to a speaker assembly having a woofer and a tweeter assembled together.

2. Description of Related Art

In some applications, a speaker assembly is provided with both a woofer and a tweeter to increase the frequency range of sound. Generally, the woofer and the tweeter are individually mounted into different locations of a housing. Thus, the assembly process is time consuming, and the woofer and the tweeter occupy a large amount of space within the housing.

What is needed, therefore, is a speaker assembly to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, all the views are schematic, and like reference numerals designate corresponding parts throughout the views.

FIG. 1 is a cross-sectional view of a speaker assembly in accordance with an embodiment of the present disclosure.

FIG. 2 is a cross-sectional view of a woofer of the speaker assembly of FIG. 1.

FIG. 3 is a top view of a bracket of the speaker assembly of FIG. 1.

### DETAILED DESCRIPTION

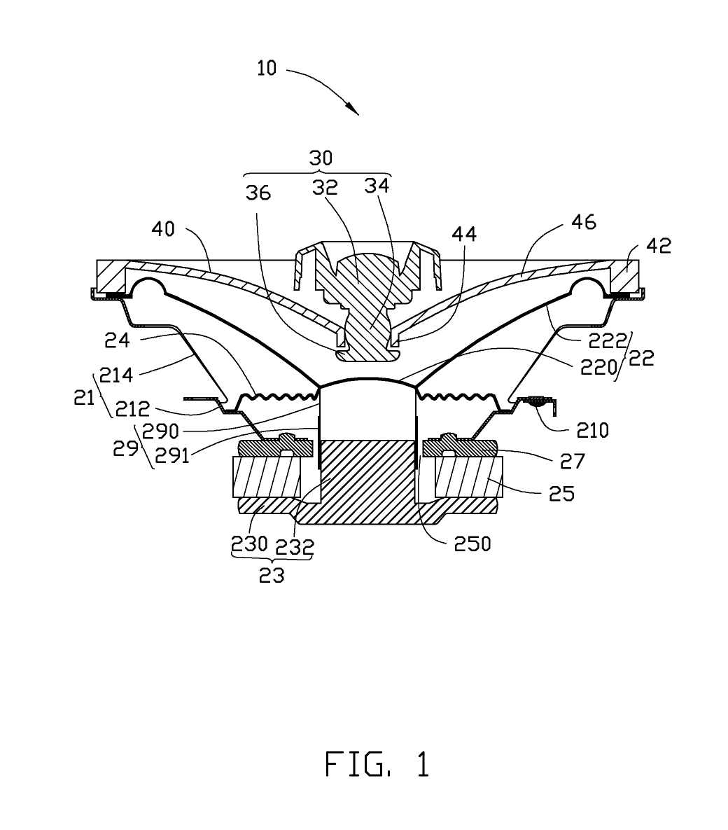

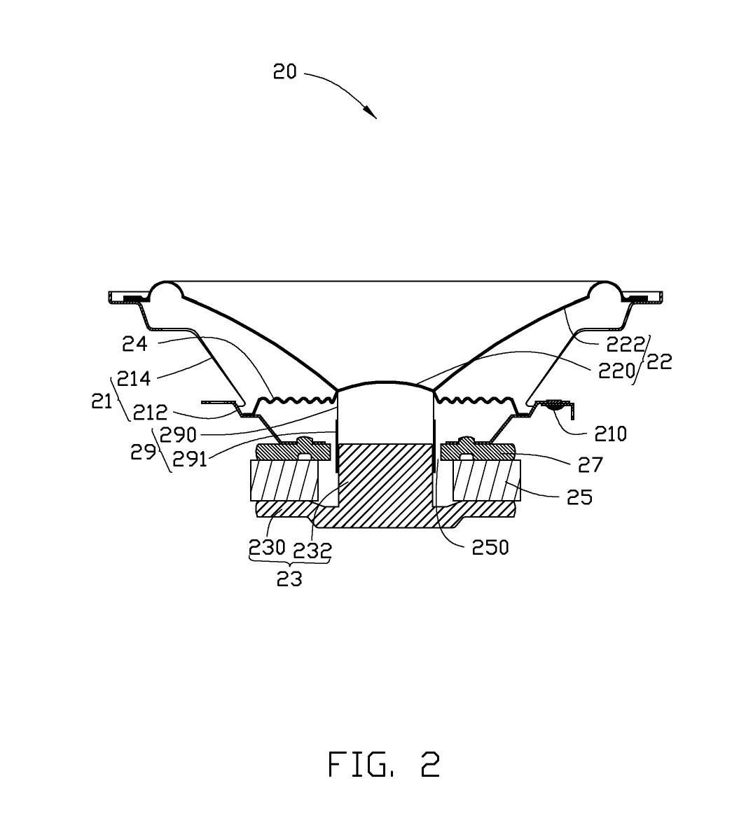

FIGS. 1-2 show details of a speaker assembly 10 in accordance with an exemplary embodiment of the present disclosure. The speaker assembly 10 includes a woofer 20, a tweeter 30, and a bracket 40 supporting the tweeter 30 substantially within the woofer 20.

The woofer 20 includes a frame 21, a yoke 23, a magnet 25, a washer 27, a voice coil 29, a diaphragm 22, and a damper 24.

The yoke 23 has a substantially T-shaped cross-section, and includes a circular bottom wall 230 and a cylindrical post 232 extending upward from a center of the bottom wall 230. The bottom wall 230 has a diameter larger than that of the post 232. The magnet 25 and the washer 27 each are annular. The magnet 25 and the washer 27 are successively superposed on the bottom wall 230 of the yoke 23, and surround the post 232 of the yoke 23. Inner circumferential surfaces of the washer 27 and the magnet 25, and an outer circumferential surface of the post 232 of the yoke 23, cooperatively define an annular magnetic gap 250 therebetween. In this embodiment, the yoke 23, the magnet 25 and the washer 27 cooperatively constitute a magnetic circuit unit for the woofer 20 with the magnetic gap 250 therein.

In other embodiments, the woofer 20 can be provided with another kind of conventional magnetic circuit unit, such as a magnetic circuit unit including a U-yoke having a U-shaped cross-section, a disc-shaped magnet and a disc-shaped washer. The disc-shaped magnet and the disc-shaped washer are received in the U-yoke.

The frame 21 is generally horn-shaped, and includes a lower portion 212 and an upper portion 214 connecting the lower portion 212. The lower portion 212 and the upper portion 214 each have a bottom end smaller than a top end thereof, and the bottom end of the upper portion 214 is smaller than the top end of the lower portion 212. The bottom end of the lower portion 214 of the frame 21 is disposed on and connected to the washer 27. Alternatively, the washer 27 can be integrally formed with the lower portion 212 and the upper portion 214 of the frame 21 as a single monolithic piece of the same material. The frame 21 forms an electrical terminal 210 on the top end of the lower portion 212, at one side of the top end of the lower portion 212.

The voice coil 29 includes a hollow cylindrical bobbin 290, and a coil 291 wound around a bottom portion of the bobbin 290. A bottom portion of the voice coil 29 encloses a top portion of the post 232 of the yoke 23 therein. The bottom portion of the voice coil 29 including a bottom portion of the coil 291 is interposed in a top portion of the magnetic gap 250. The coil 291 is electrically connected to the electrical terminal 210 so that electricity can flow to the coil 291 through the electrical terminal 210. In the magnetic gap 250, the coil 291 can be driven to move up and down along an axial direction of the bobbin 290 when the coil 291 is electrified.

The diaphragm 22 is formed from a resin or a paper material into a cone shape. The diaphragm 22 is arranged in the frame 21 around the voice coil 29. The diaphragm 22 includes a central portion 220, and a suspending edge 222 surrounding and connecting the central portion 220. The central portion 220 of the diaphragm 22 is secured to a top portion of the voice coil 29, whereby the diaphragm 22 can move together with the voice coil 29. A top end of the suspending edge 222 of the diaphragm 22 is secured to the top end of the upper portion 214 of the frame 21. The damper 24 is formed from a resin-impregnated cloth or a thin resin plate into a ring shape. The damper 24 is located between the diaphragm 22 and the bottom end of the lower portion 212 of the frame 21, and encloses the voice coil 29. An inner peripheral edge of the damper 24 connects the voice coil 29, and an outer peripheral edge of the damper 29 connects the frame 21. Thereby, irregular vibration of the diaphragm 22 is prevented, and sound quality is improved.

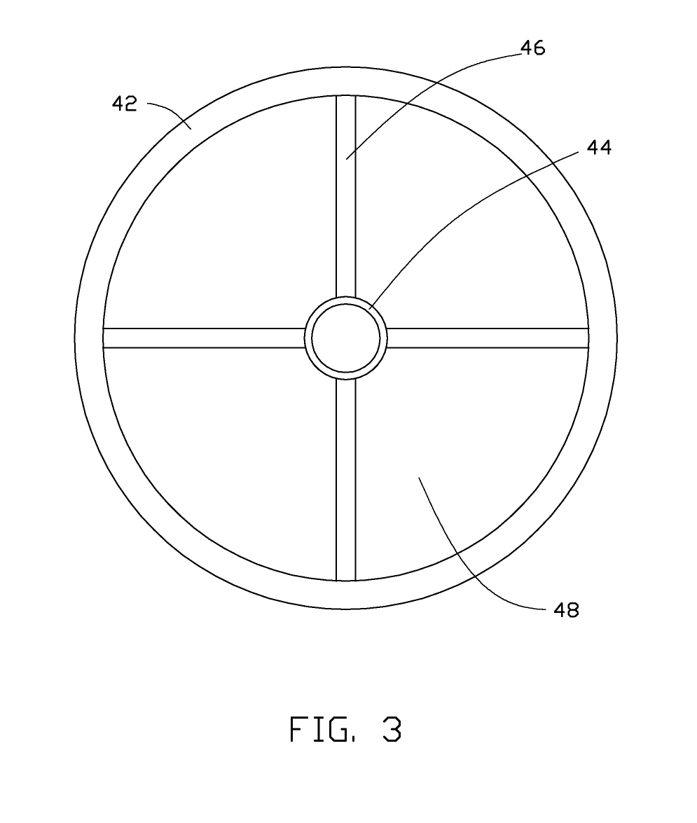

Also referring to FIG. 3, the bracket 40 includes an outer ring 42, an inner ring 44 surrounded by the outer ring 42, and a plurality of ribs 46 interconnecting the inner ring 44 and the outer ring 42. A plurality of openings 48 are defined between the ribs 46 for allowing sound produced by the diaphragm 22 to pass through the bracket 40. The bracket 40 may be made of a single monolithic piece of a rigid material such as plastic, metal or the like. The outer ring 42 is fixed on the top end of the suspending edge 222 of the diaphragm 22, to secure the bracket 40 with respect to the frame 21. Each rib 46 is curved downwardly from the outer ring 42 towards the inner ring 44. The inner ring 44 is located above the central portion 220 of the diaphragm 22.

The tweeter 30 is attached to the inner ring 44 so that the tweeter 30 is suspended above the central portion 220 of the diaphragm 22 by support of the bracket 40. The tweeter 30 includes a main body 32, a supporting body 34, and a confining body 36. The main body 32 has a configuration similar to that of the woofer 20, and can produce sound when being electrified. Note that the hatching of the main body 32 seen in FIG. 1 is for schematic purposes only, and is not intended to depict detail of the main body 32. The main body 32 is electrically connected to the electrical terminal 210 through a wire (not shown).

The supporting body 34 interconnects the main body 32 and the confining body 36. The supporting body 34 has a curved outer circumferential surface, wherein a diameter of the supporting body 34 gradually increases from a top to a middle thereof, and then gradually decreases from the middle thereof to the bottom thereof. That is, the supporting body 34 has a largest diameter at the middle thereof as measured along a height direction of the supporting body 34, and a smallest diameter at the top and the bottom thereof as measured along the height direction of the supporting body 34. The supporting body 34 is partly received in the inner ring 44 in a manner that the outer circumferential surface of the supporting body 34 interferingly abuts against an inner circumferential surface of the inner ring 44. The supporting body 34 is thus rotatable with respect to the inner ring 44 when force is applied to the supporting body 34 to overcome the interfering engagement of the supporting body 34. In this way, the orientation of the main body 32 can be adjusted. Thereby, the sound produced by the tweeter 30 can be controlled to propagate towards a desired location(s).

The confining body 36 is formed on the bottom of the supporting body 34. The confining body 36 is spaced a distance from a bottom surface of the inner ring 44.

The confining body 36 has a diameter larger than an inner diameter of the inner ring 44, and larger than the largest diameter of the supporting body 34. The confining body 36 is used to confine over-rotation of the supporting body 34 to prevent the main body 32 from abutting against the ribs 46, and also prevent the supporting body 34 from accidentally disengaging from the inner ring 44.

In the speaker assembly 10, the tweeter 30 is mounted on the frame 21 of the woofer 20 via the bracket 40. When the speaker assembly 10 is mounted to a casing (or housing), the assembly process is convenient and the speaker assembly 10 occupies a relatively small space inside the casing.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker assembly comprising:
a woofer comprising:
a magnetic circuit unit defining a magnetic gap therein;
a frame mounted on the magnetic circuit unit;
a diaphragm connected to the frame; and
a voice coil fixed to the diaphragm and extending into the magnetic gap;
a bracket comprising an outer ring fixed relative to the frame and an inner ring surrounded by the outer ring; and
a tweeter attached to the inner ring.

2. The speaker assembly of claim 1, wherein the bracket further comprises a plurality of ribs interconnecting the inner ring and the outer ring.

3. The speaker assembly of claim 2, wherein the bracket further comprises a plurality of openings defined between the ribs.

4. The speaker assembly of claim 2, wherein each rib is curved downwardly from the outer ring towards the inner ring.

5. The speaker assembly of claim 1, wherein the tweeter comprises a main body and a supporting body connecting the main body, the main body being operable to produce sound, and the supporting body being engaged in the inner ring.

6. The speaker assembly of claim 5, wherein the supporting body is interferingly engaged in the inner ring, and is rotatable relative to the inner ring when force is applied to the supporting body to overcome the interfering engagement of the supporting body with the inner ring.

7. The speaker assembly of claim 6, wherein the supporting body has a curved outer circumferential face interferingly abutting against an inner circumferential face of the inner ring.

8. The speaker assembly of claim 5, wherein the tweeter further comprises a confining body formed on a bottom of the supporting body, the confining body having a diameter larger than an inner diameter of the inner ring.

9. The speaker assembly of claim 8, wherein the confining body is spaced a distance from a bottom of the inner ring.

10. The speaker assembly of claim 1, wherein the diaphragm comprises a central portion connecting the voice coil, and a suspending edge surrounding the central portion.

11. The speaker assembly of claim 10, wherein the tweeter is suspended above the central portion of the diaphragm by the bracket.

12. The speaker assembly of claim 1, wherein the magnetic circuit unit comprises a yoke, and a magnet and a washer stacked on the yoke, the frame being attached on the washer.

13. The speaker assembly of claim 12, wherein the yoke comprises a bottom wall and a post extending upwardly from a center of the bottom wall, the magnet and the washer surrounding the post, and the magnetic gap being defined between an outer circumferential face of the post and inner circumferential faces of the magnet and the washer.

14. The speaker assembly of claim 13, wherein the magnetic circuit unit further comprises a damper, and the damper has an inner end connecting the voice coil and an outer end connecting the frame.

15. A speaker assembly comprising:
a woofer comprising:
a magnetic circuit unit defining a magnetic gap;
a frame attached to the magnetic circuit unit;
a diaphragm attached to the frame; and
a voice coil attached to the diaphragm and extending into the magnetic gap;
a bracket comprising an outer peripheral portion attached to the frame and an inner peripheral portion; and
a tweeter interferingly attached to the inner peripheral portion of the bracket, wherein the tweeter is rotatable with respect to the bracket when external force is applied to overcome friction between the tweeter and the inner peripheral portion of the bracket.

16. The speaker assembly of claim 15, wherein the inner peripheral end of the bracket comprises an inner ring, and the tweeter comprises a supporting body having a curved outer circumferential face interferingly abutting against an inner circumferential face of the inner ring.

17. The speaker assembly of claim 16, wherein the outer peripheral end of the bracket comprises an outer ring surrounding the inner ring, the bracket comprising a plurality of ribs interconnecting the outer ring and the inner ring.

18. The speaker assembly of claim 16, wherein the tweeter further comprises a confining body formed on a bottom of the supporting body, the confining body having a diameter larger than an inner diameter of the inner ring and being spaced a distance from a bottom of the inner ring.

19. The speaker assembly of claim 18, wherein the tweeter further comprises a main body formed on a top of the supporting body, the main body being operable to produce sound.

20. The speaker assembly of claim 16, wherein the diaphragm comprises a central portion connecting the voice coil and a suspending edge connecting the frame, the tweeter being suspended above the central portion of the diaphragm.
